(19) United States
(12) Patent Application Publication
(10) Pub. No.: US 2022/0397637 A1
(43) Pub. Date: Dec. 15, 2022

(54) Intelligent Radar Source Location and Alerting System and Methods

(71) Applicant: The Whistler Group, Inc., Bentonville, AR (US)

(72) Inventor: Michael Batten, Littleton, MA (US)

(21) Appl. No.: 17/742,683

(22) Filed: May 12, 2022

Related U.S. Application Data
(60) Provisional application No. 63/187,827, filed on May 12, 2021.

(51) Int. Cl. G01S 7/02

(52) U.S. Cl. CPC G01S 7/021

(57) ABSTRACT

A radar detection apparatus for creating discrete zones of no alert coverage for unwanted radar sources according to the environmental conditions of the location of the radar source and surrounding areas.

### PRIORITY CLAIM

This application claims benefit of U.S. Provisional Patent Application No. 63/187,827 filed May 12, 2021, which is incorporated in its entirety herein by reference.

### TECHNICAL FIELD

This disclosure relates generally to radar detectors and specifically to creating discrete zones of no alert coverage for unwanted radar sources according to the environmental conditions of the location of the radar source and surrounding areas.

### BACKGROUND

There are many different radar sources that share the same band of frequencies as those used by law enforcement. These can be radar based door openers located at the entry of public buildings, radar controlled traffic lights, radar drones placed on trailered signs at road construction sites, or radar-based speed signs strategically placed to slow down traffic in areas such as school zones, railroads, main entry in towns and cities, and other areas of concern.

A long-standing issue with police radar detectors is that they also detect and alert to these unwanted sources of radar that share the same band of frequencies utilized by law enforcement. These unwanted alerts may cause a user to second guess an alert thinking it might be from an unwanted radar source, thus increasing the risk of discounting a “real” alert from a law enforcement radar system.

Prior to the use of GPS, methods to reduce the annoyance of unwanted alerts required the customer interact with the unit to enter a special City, Quiet, or Mute mode that silences or provides an alternate alert when selected. The application of these City, Quiet, and Mute modes have the same effect on all radar systems. Typically, this is an “all or nothing” feature that cannot distinguish wanted from unwanted radar systems.

With the addition of early Global Positioning Systems (GPS), a radar detector containing a built in GPS module determines vehicle speed and can automatically reduce the radar detectors sensitivity or ability to alert when driving slowly or below a preselected speed. However, methods such as these that are a function of vehicle speed might be helpful in areas where lower speeds are common, but do not address unwanted radar systems along highways where travel is at higher speeds.

As GPS accuracy improved, some adopted a method to store the fixed location of unwanted radar sources and assign a simple predetermined radius from the stored location. Once the radar detector enters the zone defined by the stored radius from an unwanted radar source location, the audio and/or alert is altered to automatically reduce the annoyance of the radar detector.

For some of these unwanted radar sources, the detection range may be less than a few hundred yards due to the location and/or mount angle of the radar device. For other locations such as a long straightaway road, the radar can travel much further and be detectable from a much greater distance.

For unwanted radar systems resulting in short range detection, a small radius surrounding the system location is sufficient. A small radius, however, is not sufficient to address unwanted radar systems positioned on straightaways that can be detected from much greater distances.

For unwanted radar systems resulting in long range detection, a large radius surrounding the unwanted system location is necessary to be effective. A large radius, however, may alter or not provide an alert when driving on an adjacent road, away from the road on which the stored unwanted radar source is located. This is due to the large zone of “no alert” filtering due to the large radius from the source. Thus, if the driver encounters a law enforcement radar source when the radar detector is still be within the large “no alert” radius of the stored unwanted radar source, the driver will not be alerted and a speeding ticket will likely ensue. Methods based on a stored location having a preselected radius may be helpful but do not address the variety of detection distances from today's highly sensitive radar detectors.

Another method was created to utilize a small radius when travelling below a predetermined speed and a larger radius when travelling above a predetermined speed. Unwanted radar systems, however, can be placed on long straight roads having a low speed limit resulting in the alerting of the unwanted radar source at a distance outside the small radius. As a result, the device will continue to alert until the radar detector enters the smaller radius defined by the vehicle speed.

This type of method that stores the location and applies either a small or a large, preselected radius based on vehicle speed is limited for it does not address the variety of detection distances today's highly sensitive radar detectors can achieve.

### SUMMARY

While known methods provide some relief to unwanted alerts that meet some predefined requirements of a particular method, none of them allow the radar detector to conform to the individual conditions for each of the unwanted sources. There is a need, therefore, for intelligently identifying and storing unwanted source locations and setting a customized filtering zone radius size for the particular location according to a variety of factors, including the environment of the source location.

The environment of the location refers to, among other things, whether the road approaching the detector is straight or winding, whether there are obstructions surrounding the source, the speed limit on the road on which the driver will travel to pass the source, the direction that the source faces, and the like. These and other factors determine the strength of the signal received by the radar detector at various distances. According to sensing a signal of a predefined level and a particular distance, a discrete zone of filtering will be set. Multiple such discrete zones are created and virtually linked to form a quiet corridor covering primarily the path of travel along the road on which the source is located. This quiet corridor results in more effective filtering and no alerts for false sources while reducing erroneous no alert conditions for real sources.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings and photographs, wherein:

FIG. 1 depicts an aerial view of a radar source location and associated no alert zones.

FIG. 2 depicts an aerial view of a radar source location and associated no alert zones.

FIG. 3 depicts an aerial view of a radar source location and associated no alert zones formed by an automatic learning radar detection method according to an embodiment of the invention.

FIG. 4 depicts an aerial view of multiple radar source locations and associated no alert zones.

FIG. 5 depicts an aerial view of multiple radar source locations and associated no alert zones associated with each source formed by an automatic learning radar detection method according to an embodiment of the invention.

FIG. 6 is a flowchart of an automatic learning radar detection method according to an embodiment of the invention.

FIG. 7 is a flowchart of an automatic unlearning radar detection method according to an embodiment of the invention.

### DETAILED DESCRIPTION OF THE EMBODIMENTS

The detailed description set forth below is intended as a description of the present embodiments of the invention and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Several embodiments of the invention will now be described with reference to the drawings. Unless otherwise noted, like elements will be identified by identical numbers throughout all figures. The invention illustratively disclosed herein suitably may be practiced in the absence of any element which is not specifically disclosed herein.

An automatic learning, or “auto learn” method of the present invention is based upon a relatively small radius capable to connect or link with another small radius. This series of links or chain of small radii are interconnected to effectively overlap. The end result of these interconnected overlapping radii comprises 2, 3, 4 or more radii forming a corridor.

The presently described auto learn method addresses the shortcomings of previous methods and is effective for both short range and long-range detections independent of vehicle speed. These linked smaller radii form a narrow corridor of an area covered by the radar detector, thus minimizing the opportunity to not alter or not provide an alert of a legitimate law enforcement radar source if travelling on an adjacent road.

The presently described auto learn method improves upon previous manufacturer methods by removing vehicle speed as a variable, making the method effective at any speed.

The presently described auto learn method does not require the storage of signal strength, time, direction of travel, nor does it make an attempt to calculate the specific location of the radar source.

The presently described auto learn method of suspect radar sources requires storage of the source frequency, the date, and the latitude/longitude location of the detection of the suspect source when the detected signal strength reaches a predefined level. In one embodiment, the device performing the methods described herein is a radar detection device comprising a processor and associated source code stored in device memory and executable by the processor to perform the steps of the various methods disclosed herein. The radar detector in one embodiment includes a GPS module and antenna that communicates GPS data, including location data of a vehicle to the detector's processor.

The method herein described seeks to learn a location that is offset to the front side of the radar source. To determine an offset location to the front side of the radar source allows a smaller radius to be used as the detection range when approaching a radar source from its front side is substantially different then when approaching the same radar source from the rear. Using a small radius is less problematic when driving on adjacent roadways near the radar source as alerts stemming from suspect radar sources are eliminated.

The presently described method comprises creating an interconnected overlapping radius, which is the function of storing multiple locations separated by the selected radius should the unit reach or exceed a predetermined signal strength of a nuisance band, starting with the first stored location. When the vehicle leaves or exits the predefined radius range of the first stored location, should the unit continue to reach or exceed the predetermined signal strength of a nuisance band, a second location is stored. This process is repeated until the signal strength falls below the predetermined signal strength of the nuisance band.

Comparing results from encounters with source signals on different days will confirm with a high degree of certainty the existence of a physical nuisance radar source and will enable the unit to alter or not provide an alert of the received signal when driving thru this area in the future.

The presently described auto learn method also comprises an auto unlearn method. In order to confirm with a high degree of certainty, when within a smaller predetermined radius of a previously auto learned stored location radius there is no detection of the nuisance source, it can be noted. Comparing results from encounters of multiple different days will confirm with a high degree of certainty the physical nuisance radar source has been removed. This previously auto-learned location is then deleted from memory to make room for new stored locations.

Traditional methods to set a radius centered around a nuisance radar source location require a large radius of coverage when vehicle is approaching the front side path of the nuisance radar source. If vehicle is travelling on other roadways within the large coverage radius in proximity to the nuisance radar source, the radar detector will likely not alert to a legitimate radar speed trap or radar source within the large coverage radius area, believing that the source is a nuisance radar source. This is the problem with traditional learning methods and systems—they filter out too many potentially legitimate sources.

The presently described system and method, on the other hand, utilizes a smaller radius and links them together to create a narrow corridor of coverage. In this manner, the number of ignored sources is limited to a discrete area based on repeated results from traveling a road with regularity. This reduces the risk of eliminating detection of radar sources when travelling on roadways not in the intended path of the radar.

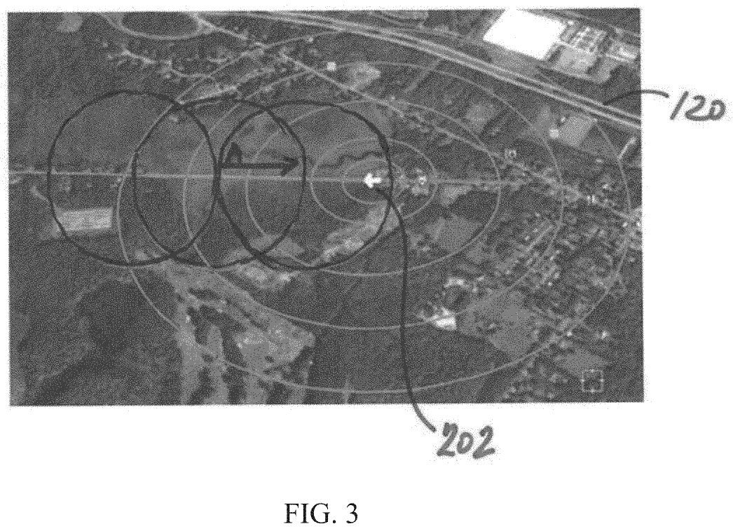

A method according to an embodiment of the present invention is described with reference to FIGS. 3, 5, 6 and 7. In one embodiment, an initial alert of X or K band radar signal sets a counter loaded with first value of (Y) and decremented by 1 each time an alert of the same band is received if within the same radius as a previous alert (to qualify as a new subsequent alert for this location, some difference in time from previous alert must be considered to prevent multiple decrement events from the same encounter should the unit alert, stop, then alert again), when counter reaches 0 the unit has alerted to the same band at this location on (Z) separate occasions and is assumed to be a fixed location that can be stored as an auto learned X or K quiet location.

In an embodiment, before storing the auto learned X or K quiet location, the user is notified that the location will be stored unless the user interacts with the unit to reset the counter. For example, in one embodiment the user depresses a “quiet button” to cancel this storing of the X or K quiet location and reset the counter. If the user does not interact to cancel this storage, the X or K quiet location is automatically saved (“auto saved”).

When determining the specific waypoint to be stored, it is optimal or desirable to store the location where the detected signal strength reaches a predetermined level. In one embodiment, on a scale of 1 to 10, with 10 being the strongest level of signal detection, detection of a signal at level 9 invokes storage of the location. Other measurement scales or protocols could be deployed depending upon the detection device. Importantly, signals sensed or detected of at least a minimum intensity invokes the auto learning and storage process of the present invention.

Notably, comparing locations and extrapolating a central location for the (Z) different encounters is not necessary. The benefit to not storing the actual location of the source as a smaller radius can be effective and create fewer unforeseen issues.

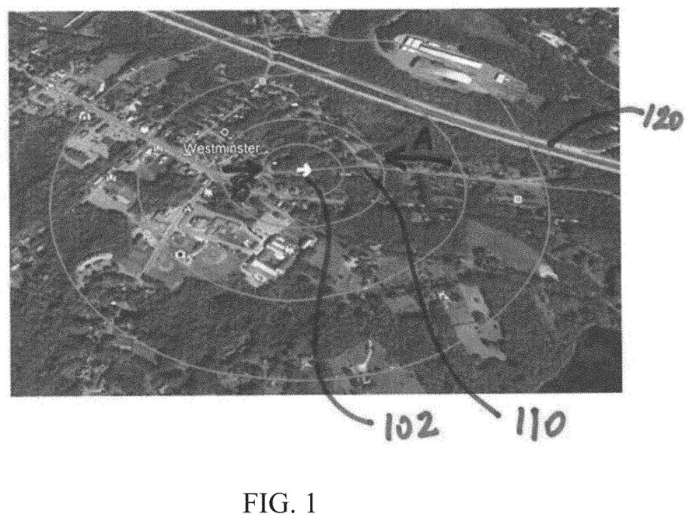

FIG. 1 depicts an aerial view or map in which a device performing the methods described herein operates. In FIG. 1, a radar source 102 emitting a K band signal faces or emits a signal in the direction in which the arrow faces. A vehicle traveling in direction A travels on the road towards source 102. In other words, a vehicle traveling in direction A approaches the source 102 from the front side. As a vehicle approaches source 102 traveling in direction A, the road has a bend 110 the apex of which is approximately 150 meters from source 102.

Source 102 serves as the center point of concentric circles extending from the source. In one embodiment, the inner most circle in FIG. 1 has a radius of 100 m from source 102, the next circle has a radius of 200 m, the next 400 m, the next 600 m. The radius of each circle is based upon the efficacy of the detection device. The actual values can differ.

Along driving path A as shown in FIG. 1 are many other nearby streets that one can travel on and be within the selected radius. If, for example, the radar detector learns that source 102 is a nuisance source and is set to eliminate alerts within a 600 meter radius from it, then other false and true sources along other roads that fall within the radius will be eliminated. As can be seen from the map, in a relatively densely populated urban area there are many side streets within the zone or radius that may not be traveled but nevertheless can be the location of true radar sources. In the map, a large portion of a two-lane highway 120 that is nearly parallel to the radar source falls within the region. Therefore, radar sources within that radius would also not result in alerts. This is problematic.

The table immediately below reflects the K band speed signal when approaching the radar source from the front. Note that the bend in the road 150 meters before the source when approaching from the front impacts signal intensity.

TABLE 1

| | Distance From Source (m) | | | | | | | |
|---|---|---|---|---|---|---|---|---|
| | 300 | 250 | 200 | 150 | 100 | 50 | 0 | 50 |
| Signal | 1 | 4-6 | 8 | 9 | 9 | 9 | 9 | 7 |
| Intensity | | | | | | | | |

As indicated in Table 1 above, when the vehicle comes within approximately 150 feet, the signal intensity value is nine and continues at that level until reaching the source (distance=0 meters). Once the vehicle passes the source, the signal intensity value decreases. In one embodiment, the reaching of a predefined signal intensity value invokes the process of identifying and storing the location of the vehicle when the predefined signal intensity value. In this process, the storage of the location of the vehicle is a first offset location in relation to the actual location of the radar source. This allows a smaller radius to be effective and minimize filtering coverage of other roads that may fall into this “quiet” location or zone. In one embodiment, the smaller radius is 400 meters, although zones of other radii can be selected.

The offset location method also applies when the vehicle is approaching from the rear of the radar source. What is meant by “frontside” and “rear” or “backside” is the direction of the vehicle in relation to the direction in which the radar source emits its signal. In the example and table above when the vehicle approaches the source from the frontside, the vehicle's radar detector will sense the source from a longer distance than it would when approaching the source from the backside. When approaching from the rear the signal from the source in the direction of the oncoming vehicle are relatively weak and, thus, the detector must be close to the source to detect the signal.

Table 2 below provides an example of the level of signal intensity at various distances from the source when approaching the source from the rear. Note that in this example, there are no high intensity measurements (such as 9 on a 1 to 10 scale) when approaching the source from the rear.

TABLE 2

| | Distance From Source (m) | | | | | | | |
|---|---|---|---|---|---|---|---|---|
| | 300 | 250 | 200 | 150 | 100 | 50 | 0 | 50 |
| Signal | 0 | 0 | 0 | 4 | 5 | 4 | 2 | 0 |
| Intensity | | | | | | | | |

In the examples of Table 1 and Table 2, approaching the source 102 when travelling in direction A requires a radius of 400 meters if the location of the source is stored. Traveling in direction B, however, requires a radius of 200 meters if the location of the source is stored. As there is only one radius that can be selected, the larger of these must be chosen in order to ensure the unit is quiet when traversing this area. Storing a location offset to the forward facing side of the source allows a single smaller radius of 300 meters to be as effective to this area.

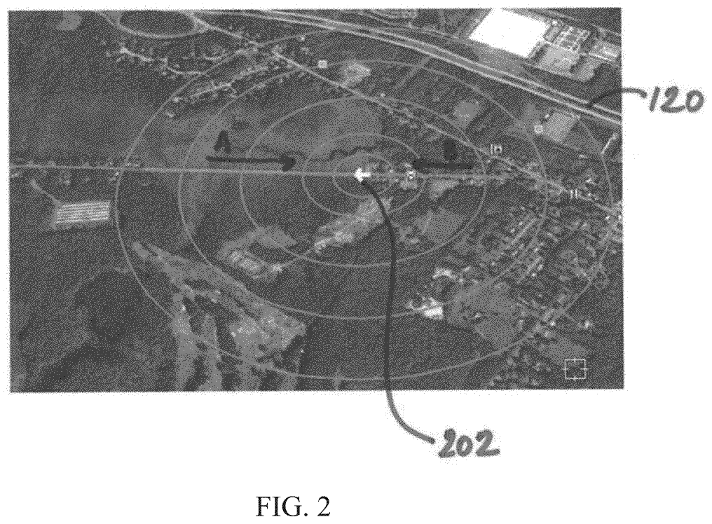

FIG. 2 and the corresponding tables below pertain to another example of distances at which a predefined level of signal strength is reached at various distances. In FIG. 2, radar source 202 is shown with the same concentric circles and corresponding radii emanating from source 202 as the center, with the most outer radius being 800 meters. A traveler on path A approaches source 202 from the front side and a traveler on path B approaches source 202 from the rear. The road approaching source 202 in FIG. 2 is largely a straightaway. Table 3 below shows signal strength on the 1 to 10 scale based on distance from the source.

TABLE 3

| | Distance From Source (m) | | | | | | | |
|---|---|---|---|---|---|---|---|---|
| | 900 | 750 | 600 | 450 | 300 | 150 | 0 | 150 |
| Signal | 1 | 3-4 | 6 | 8-9 | 9 | 9 | 8 | 0 |
| Intensity | | | | | | | | |

As shown in the table above, K band radar source 202 on a straight away begins alerting approximately 1000 meters from the source when approaching the source from the front side on path A. If the method for storing the location is invoked at a signal reaching intensity level 9, then the location offset from the source by a distance of 400 meters is set. Table 4 below provides signal intensity and distance when approaching source 202 from the rear.

TABLE 4

| | Distance From Source (m) | | | | | | | |
|---|---|---|---|---|---|---|---|---|
| | 900 | 750 | 600 | 450 | 300 | 150 | 0 | 150 |
| Signal | 0 | 0 | 0 | 2-3 | 4-5 | 6 | 4 | 3-2 |
| Intensity | | | | | | | | |

As shown in the table above when approaching source 202 from the rear on a straightaway on path B, there is a relatively low intensity reading from approximately 450 to 0 meters from the source. The reading becomes stronger at roughly 150 meters from the source. When approaching from the rear, however, a high level of intensity (for example a reading of 9) is not achieved.

When driving along either path A or B, there are many other streets nearby that one can travel on and be within the selected radius and not receive radar due to the placement and direction of the radar source. The available roads includes two-lane highway 120 that is nearly parallel to the road on which radar source 202 is located.

If storing the physical source of radar source 202, a radius of 1000 meters is needed to quiet the detector if approaching from the front side due to the straight roadway. That radius, however, extends into many other areas and could prevent the radar detection unit from giving an audible alert to a true police user of K band in the general area simply because the vehicle is within this large radius. Again, this is problematic.

To resolve this according to an embodiment of the present invention, storing the location of the vehicle when the initial level 9 is reached will create and designate a first offset location to the actual source. This will allow application of a coverage or filtering area of a smaller radius such as 400 meters in one embodiment to be effective and minimize the other roads that fall into the quiet location. Filtering areas of larger or smaller radius can be used depending upon the location, geography, population density, or the like. As the vehicle with a radar detection unit exits the selected radius and is still receiving a level 9 alert, another offset location is set and stored, causing another similarly sized filtering area to be applied which overlaps the previous radius. These linked or overlapping rings extend to create a virtual corridor of individual rings each having a smaller radius than the outer ring as shown in FIGS. 1 and 2. This effectively creates a “quiet corridor” that is more surgical in storing offset locations of known nuisance sources and filtering out unwanted radar sources without “over-filtering” potentially real sources, such as police radar.

FIG. 3 depicts the coverage area of each ring having a smaller radius than the large coverage or filtered area shown in FIG. 2. The rings in FIG. 3 result from a driver having traveled many times over path A in a front side direction of source 202. The device having sensed a high intensity signal at a particular distance from the source (as shown in the table as described) the number of predefined times causes that offset location from the source to be plotted and a small radius zone of coverage to be set. As shown in FIG. 3, three such rings are set, resulting in a linked coverage area that encompasses source 202's location and a more narrow area approaching that location. This narrow area or “quiet corridor” prevents erroneous filtration of many side streets from path A on which a true radar source is likely present.

In one embodiment, this auto learn capability is invoked when the driver has multiple encounters from a direction that achieves a level 9 in order to decrement the counter enough times for that location to be saved as an auto stored X or K band quiet location. In another embodiment, the band and frequency are stored and if the conditions of a signal received are different than the previously stored data for that area, then the device alerts the user, and the user can respond accordingly.

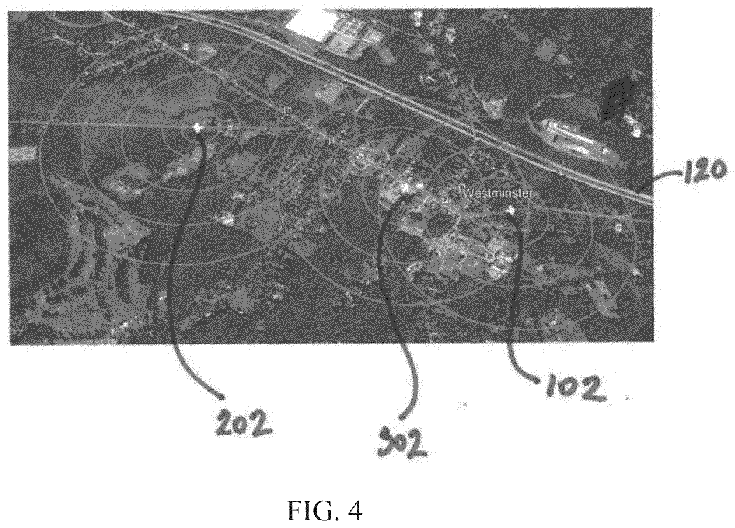

FIG. 4 is another map of the same general vicinity as the maps in previous figures. As shown in FIG. 4 there is a third source 302. Recall that sources 102 and 202 emit signals in a direction parallel with the direction of travel on the associated road of interest. For source 302, however, signals are emitted perpendicular to the direction of travel on the associated road. Source 302 may be a food store with K band door openers facing the direction of the arrow. Because the signal from source 302 travel perpendicular to the road, a vehicle's radar detection unit in many instances will only alert to that source when driving perpendicular to it even within a 100-meter radius and at low signal strength of 1 or 2 or 3. If the vehicle enters the parking lot of the store, however, travel will be directly towards source 302. This will cause the signal alert to reach a level 9.

As shown in FIG. 4, if all three of these source areas are saved as a quiet location, when applying concentric small radius areas, even a small radius of 400 meters from source 302, will overlap the 400 meter radius zone of source 102 and almost overlap the 400 meter radius of source 202. This greatly captures streets other than the paths of travel, eliminating too many potentially real sources.

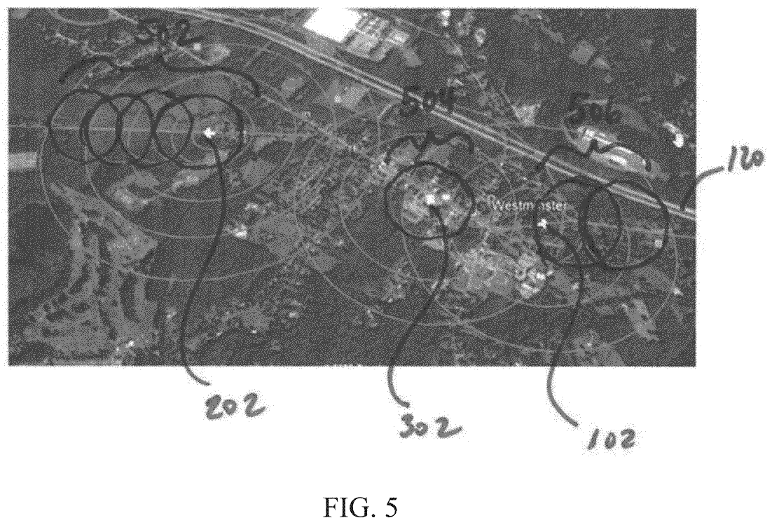

As shown in FIG. 5, forming a “quiet corridor” of circles of smaller radius connected together akin to links of a chain greatly reduces the number of streets and areas other than the identified paths of travel that are filtered out. As shown in FIG. 4, all of the area within the outermost ring emanating from each source 102, 202, and 302 acts as a filter to eliminate all signals from sources the detector would otherwise sense. As shown in FIG. 5, however, only the area within the quiet areas 502, which is comprised of four linked rings, 504, which is comprised of a single ring, and 506 comprised of two rings, act as a filter to eliminate alerts. In one embodiment, the radius of each of these quiet corridor rings is 200 meters, but other distances can be applied.

The auto learn capability described herein includes storage of source signal band and frequency to allow the unit to be “smart” and alert if the conditions are different than the stored conditions for that location.

Additionally, in one embodiment the unit provides a notification even in a filtered quiet area if another X or K band source is in use that differs from the X or K band source saved for that location. This notifies the driver of a new potential threat. In one embodiment, a method to alert to a possible law enforcement officer running K band when in the same radius as a marked quiet location are as follows.

If receiving a frequency that +/−25 MHz or greater than the stored frequency for that quiet location, provide normal alert. In addition, if an auto stored location frequency is within the X band and a K band signal is received, provide normal K band alert as the auto stored quiet location is specific to X band in this scenario.

In an embodiment, a method for automatic unlearning of a source location or source location offset is performed via a processor of a detection device and code stored in memory of the device and executable by the processor. The “auto unlearn” process occurs when after an offset location is stored to correspond to a known or learned source, there is no longer an X or K band radar source present within the previously designated radius of that location. In one embodiment, on the user's radar detector, an indicator, such as a GPS icon is replaced with a basic location icon to remind the user travel is taking place in a currently an auto stored location.

In some embodiments, the detector includes functionality through which the user manually stores a quiet location. This is in addition to the auto learn functionality that requires no manual information entry by the user. In one embodiment, the auto unlearn capability described above will not automatically delete a previously manually stored X or K band quiet location designation. Such a manual designation requires a manual deletion. On the other hand, a manual X or K band quiet location delete function can be used to manually delete an auto stored quiet location.

In one embodiment, if a vehicle with a detection device programmed to perform the presently described methods passes within a 100-meter radius of an auto stored X or K band quiet location and there is no X or K band alert, the process to unlearn the X or K band quiet location in the same way a location is stored. After achieving no X or K band alert within 100 meters on (Y) separate occasions for that location, automatically notify the user that this X or K band quiet location will be deleted from system memory. If the user takes no responsive action, the device with proceed to delete the location. Before finally auto deleting an auto learned X or K band quiet location, however, the user should be notified the location will be deleted unless the user interacts with the unit to reset the counter. In one embodiment, the user pressing a “quiet” button will cancel the deletion of the X or K band quiet location and reset the decremental counter, meaning Y more encounters of the specific 100 meter region must occur before the auto deletion process can once again be invoked.

Note that a relatively small radius, such as a 100 meter radius. requirement before logging an auto unlearn event is to prevent accidental decrement and ultimately the deletion of a stored quiet location when driving on side road that is within the selected quiet location radius but will not yield an alert due to the direction of the source and the direction of travel. For example, if 600 meters was selected for the auto unlearn threshold and the driver travels along highway 120 for example each day, the unit would auto delete 2 of these 3 previously learned locations as the unit would not have alerted based on the driving location and the location/position of the radar sources. Thus, the threshold level for the auto unlearn function must be relatively small as compared to the size of the linked rings in order to avoid excessive, unwanted or accidental unlearning.

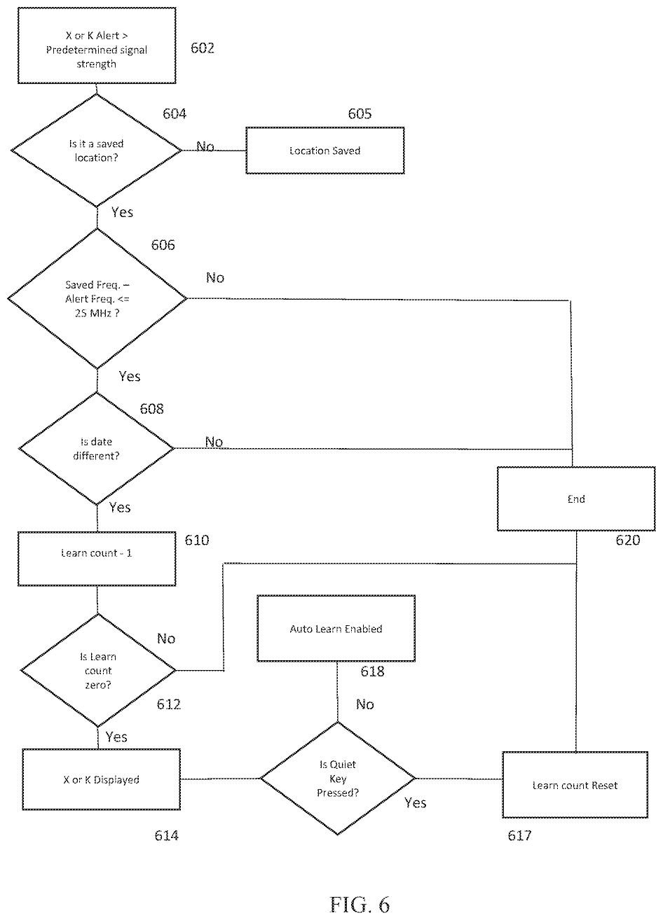

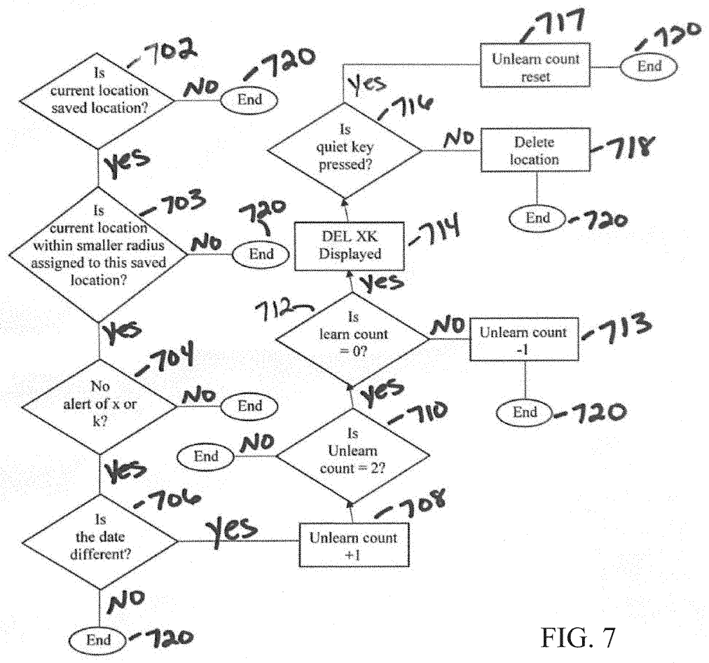

The methods described herein, including but not limited to the methods described in the flowcharts of FIGS. 6 and 7 below are performed by a processor and associated executable code contained in an electronic device such as a radar detector as is known in the art. FIG. 6 is a flowchart of the auto learn method herein described according to an embodiment of the present invention. The auto learn method of FIG. 6 starts with the sensing of a signal from a radar source. Once a signal is sensed, the process begins at step 602 where the device senses a signal that exceeds a predetermined signal strength. The method proceeds to step 604 where the device queries whether the location of the vehicle at the time the signal was sensed is a saved location. If the answer to this query is “no” then the location is saved at step 605 and the method proceeds to the end at step 620.

If, on the other hand, at step 604 the answer is “yes” and the location has been previously stored, the method proceeds to step 606 where the device queries whether the frequency of the received signal is +/−25 MHz from the frequency saved for the saved location. If the answer is no, the method ends at step 620. If, on the other hand, the answer is “yes”, then the process continues to step 608 with the query of whether the date of receipt of the signal is different from the timestamped date of the stored location. If the answer is “no”, meaning the dates are the same, the process ends at step 620. If, however, the answer is “yes”, then at step 610 the counter for the auto learn function is reduced by one. In other words, multiple encounters of a source on the same day at a saved location does not result in multiple decrements of the counter.

The auto learn method of continues at step 612 where the system queries whether the auto learn counter has reached a value of zero. If no, the process ends at step 620 and receipt of another signal from a source is awaited. If the answer to query 612 is “yes”, then then an X or K Band alert is displayed to the user via the display on the detection device. Then, at step 616 the query is posed of whether a key enabling a quiet mode has been depressed. If yes, then at step 617 the learn counter is reset. If, on the other hand, the answer at step 616 is no, then at step 618 auto learn is enabled and the process ends at step 620 and another sensed signal is awaited.

FIG. 7 is a flowchart of the auto unlearn method herein described according to an embodiment of the present invention. The method of auto unlearning location is premised on a location being stored in memory as a previously saved learned location. The auto unlearn function is invoked when the user enters the active radius of a previously stored learned location. Even though the user may not receive an alert in a learned location zone, the detector itself still senses X and K band signals. The objective is to remove locations from memory that are no longer of interest because the false source once present in that location is gone.

The auto unlearn method of FIG. 7 begins with step 702 with the query of whether the driver's current location is a location saved in memory of the detection device. If the answer is “no” at step 702, then the unlearn method ends at step 720. On the other hand, if the answer at step 702 is “yes”, then at step 703 the system queries whether the current location is within a smaller radius assigned to this saved location. If the answer is “no”, then the process ends at step 720. If, however, the answer at step 703 is “yes”, then the method continues with step 704. At step 704 the system queries whether there is no alert of an X or K band signal. If the answer is “no” at step 704, then the unlearn method ends at step 720. If the answer at step 704 is “yes”, then at step 706 the device queries whether the date of this “no alert” for this location is taking place on a date different from the last “no alert” status for this location. If the answer is “no” at step 706, the unlearn method ends at step 720.

If, on the other hand, the answer at step 706 is “yes”, then the unlearn count counter is increased by one at step 708. Next, at step 710 the device queries whether the unlearn count is two. If the answer is “no”, then the unlearn method ends at step 720. If the answer at step 710 is “yes”, then the system queries further at step 712 whether the learn count is zero. If the answer at step 712 is “no”, then at step 713 the unlearn count is decreased by one. If the answer at step 712, however, is “yes”, then the method proceeds to step 714 where an indicator or message of “DEL XK” meaning “delete X or K band location” is displayed on the display or interface of the radar detector.

Next, at step 716 the device queries whether a “quiet” key has been pressed or a “quiet” functionality has otherwise been selected. If the answer is “yes” then at step 717 the unlearn counter is reset. IF the answer at step 716 is “no”, then the method proceeds to step 718 where the location at issue is deleted. The auto unlearn method then ends at step 720.

Thus, the auto unlearn method described herein functions to clear locations where a false source is no longer present. This is achieved when the user vehicle enters the learned zone on a number of occasions, on different days, and no X or K band source is sensed. By deleting the auto learn location when the source that caused it to be learned is no longer present, the user device once again provides regular alerts to sensed source radar signals. Over time, however, through the learning method of FIG. 6, the particular location or one close to it may once again be stored as a learned location. This would invoke the process of creating smaller, discrete zones of filtering from a point offset from the source location, as described above, to provide more selective filtering.

The methods described herein are performed by a processor and associated executable code contained in an electronic device such as a radar detector.

While the disclosed embodiments have been described with reference to one or more particular implementations, these implementations are not intended to limit or restrict the scope or applicability of the invention. Those having ordinary skill in the art will recognize that many modifications and alterations to the disclosed embodiments are available. Therefore, each of the foregoing embodiments and obvious variants thereof is contemplated as falling within the spirit and scope of the disclosed inventions.

While the invention has been particularly shown and described with reference to a preferred embodiment, it will be understood by those skilled in the art that various changes in form and detail can be made therein without departing from the spirit and scope of the invention.

What is claimed is:

1. A radar detector, comprising:
an outer case;
a processor;
downloadable application program instructions; and
a storage device associated with the processor for storing the downloadable application program,
wherein the application program instructions cause inoperability of a radar detector warning indicator upon recognition of a geographic location including a learned false radar source.
